(19) United States
(12) Patent Application Publication
(10) Pub. No.: US 2008/0257907 A1
(43) Pub. Date: Oct. 23, 2008

(54) Multi-Compartment Dosing For Small Amounts

(75) Inventor: Jan-Dirk Reimers, Aachen (DE)

Correspondence Address: NORRIS, MCLAUGHLIN & MARCUS, 875 THIRD AVE, 18TH FLOOR, NEW YORK, NY, 10022, US

(73) Assignee: HERAEUS KULZER GMBH, Hanau (DE)

(21) Appl. No.: 11/572,550

(22) PCT Filed: Aug. 5, 2005
(86) PCT No.: PCT/EP05/08479

§ 371 Date: Jan. 23, 2007

(30) Foreign Application Priority Data
Aug. 10, 2004 (DE) 10 2004 038 962.4

(51) Int. Cl. B67D 5/08

(52) U.S. Cl. 222/52

(57) ABSTRACT

An apparatus for dosing small amounts of liquid or pasty media as well as media containing filling material or reactive media having a defined processing time, comprising a housing with an outlet, a dosing unit which is in communication with the outlet and is arranged in or on the housing, and a reservoir, for the medium, which is in communication with the dosing unit and is arranged in or on the housing, said apparatus consisting, in a preferred exemplary embodiment, of a housing 1 comprising an outlet 12. In addition, the apparatus comprises a dosing unit as well as a reservoir 61 for the medium. A dosing shaft 2 which is sectionally surrounded by a translation shaft 3 is arranged in the housing 1. A discharge groove 33 is inserted in the translation shaft 3, with a control button 8 which passes through a groove 17 in the housing 1 being guided in said discharge groove 33. In an alternative variant, the housing 1 is provided with a circuit 92 which actuates a dosing shaft 2 by inserting a motor 93 and a drive 94.

The invention relates to an apparatus for dosing small amounts of liquid or pasty media as well as media containing filling material or reactive media having a defined processing time, said apparatus comprising a housing which is provided with an outlet, a dosing unit which is in communication with the outlet and which is arranged in or on the housing, in addition to a reservoir for the medium, which is in communication with the dosing unit and which is arranged in or on the housing.

The delivery of defined amounts of media is known from all fields of engineering, medicine, chemistry, etc. Therein, precise dosing of the medium is usually desired. The dosing tolerances to be kept are often within percentage ranges, which can be reliably achieved with relatively low technical efforts as long as large amounts are to be dosed. However, if the amounts to be dosed are small or even very small, this poses a problem which is difficult to solve in technical terms. Small amounts of liquid media are, for example, dosed in ink-jet printers. While printing, such printers deliver approx. four to six picoliters of ink per pulse. The next higher-order dosing units, which are for example known from medical-engineering applications, are able to dose amounts of approximately 0.3 ml.

Such a syringe-type apparatus for dosing liquids or pastes has been disclosed in DE 91 07 574 U1, where a housing is provided with an outlet. A piston is arranged in said housing. A valve is pre-arranged in the region of said outlet. A dosing chamber is arranged in the region of said valve. A return spring and an actuation mechanism are provided in said housing. The apparatus is actuated by means of a lever. Moreover, there are known apparatuses working like a cartridge. The cartridge can be actuated by means of a handle. The known dosing apparatuses fulfill the requirements set. However, there are fields of application where it is known that the amounts delivered by these dosing units are too large; they are only able to dose amounts of 0.3 ml on an average. These apparatuses are not able to deliver smaller amounts. Often, the precision of the amount delivered per dosing is not very satisfactory either. Since automatic dosing is not possible, the dosing methods known from ink jet printers cannot be applied.

The invention is intended to provide a remedy to this problem. The invention aims at creating an apparatus for dosing small amounts of liquid or pasty media as well as media containing filling material or reactive media having a defined processing time, said apparatus being able to deliver dosing amounts ranging from 0.01 to 200 μl, preferrably from 0.1 to 20 μl, with high precision. According to the invention, this problem is solved by arranging a dosing shaft in the housing, said dosing shaft being sectionally surrounded by a translation shaft and a running groove being inserted in said translation shaft, with a control element which passes through a groove in the housing being guided in said running groove.

The control element can, for example, be designed as a slide, a button or a lever.

The invention provides an apparatus for dosing small amounts of liquid or pasty media as well as media containing filling material or reactive media having a defined processing time, said apparatus allowing to dose amounts ranging from 0.01 to 200 μl, preferrably 0.1 to 20 μl, with exceptionally high precision. Owing to the high dosing precision, there are manifold fields of application for the apparatus, for example in the medical field or in the microtechnical field.

In addition, the problem is solved by providing a circuit in the housing, said circuit actuating a dosing shaft by inserting a motor and, if necessary, a drive (if a stepper motor is used, the drive is not necessary).

This also creates an apparatus for dosing small amounts of liquid or pasty media as well as media containing filling material or reactive media having a defined processing time, said apparatus allowing to dose amounts ranging from 0.01 to 200 μl, preferrably from 0.1 to 20 μl, with exceptionally high precision. Moreover, by designing the apparatus with a motor, operation is clearly more comfortable for the particular user.

The problem is, thus, solved by means of apparatuses according to the independent claims.

Other further developments and embodiments of the invention are specified in the subordinate claims. An exemplary embodiment of the invention is represented in the drawing and will be described in detail below. In the figures,

FIG. 1 is a longitudinal view of the apparatus;

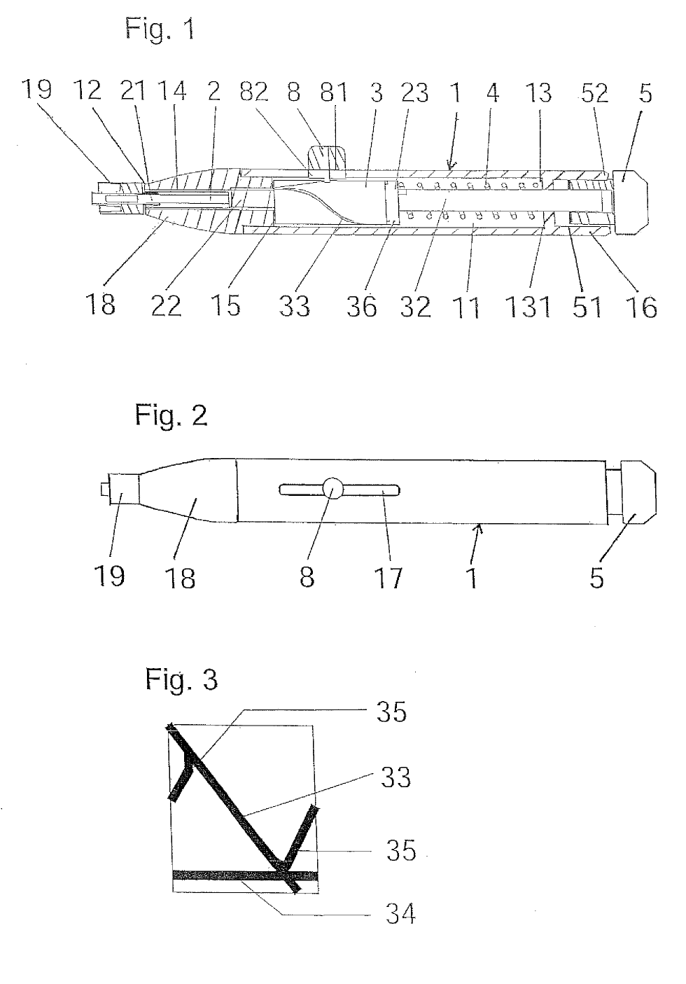

FIG. 2 is a top view of the apparatus shown in FIG. 1;

FIG. 3 is the developed view of grooves provided in the translation shaft;

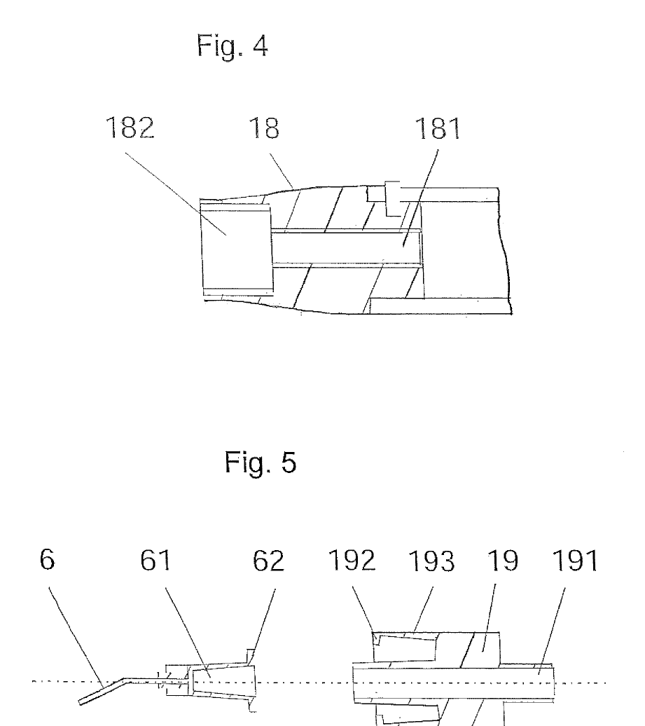

FIG. 4 is a longitudinal view of a component;

FIG. 5 is a longitudinal view of a luer-lock exchange cap with dosing needle;

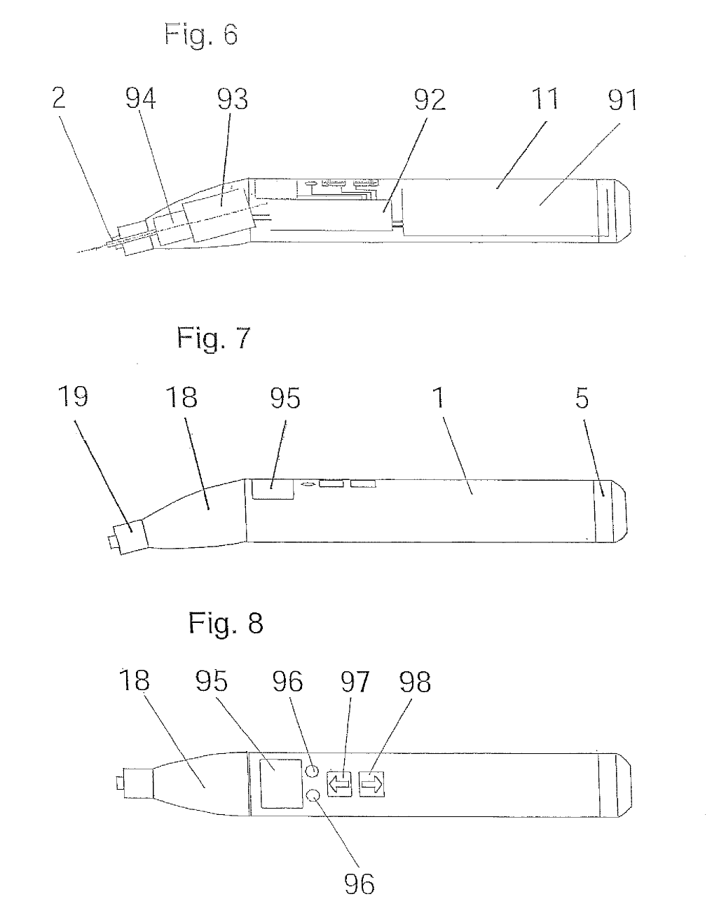

FIG. 6 is a schematic diagram of a longitudinal view of an apparatus with motor drive;

FIG. 7 is a view of the apparatus shown in FIG. 6; and

FIG. 8 is a top view of the apparatus shown in FIG. 5.

The selected exemplary embodiment of the apparatus for dosing small amounts of liquid or pasty media comprises a housing 1, with a dosing unit being arranged in said housing. Essentially, the dosing unit comprises a dosing shaft (piston) 2 which is sectionally surrounded by a translation shaft 3. The translation shaft 3 is under the effect of a compression spring 4. A rotary button 5 with indicator is provided at the end facing away from the dosing shaft 2. An exchangeable dosing needle 6 is arranged at the end facing away from the rotary button 5. In addition, the apparatus comprises a control button 8. Instead of at the rotary button 5 only, the indicator may also be provided at the visible part of the dosing shaft 2 and/or at the housing 1 and/or at the rotary button 5.

In essence, the housing 1 has a pin-like shape tapering in the region of one of its ends. Along its longitudinal centerline, it is penetrated by a hole 11 which is stepped several times. At one of its ends, said hole 11 forms the outlet 12. At its side facing away from the outlet 12, the hole 11 comprises a diameter which, apart from a low wall thickness, essentially corresponds to the diameter of the housing 1. The hole 11 is limited by a web 13 which is provided with a hole 131. In the region facing the outlet 12, an internal thread 14 is provided in the hole 11. A step 15, which is caused by the expanding diameter, is formed in the further course of the hole 11. At its end facing away from the outlet 12, the housing comprises a blind hole 16, which is arranged adjacent to the web 13, with the rotary button 5 partly immersing in said blind hole 16. The part of the housing 1, which comprises the tapering section of the outside diameter of the housing 1, is formed as a separate component 18 which can be screwed to the remaining part of the housing. This creates a two-piece housing 1 where the part of the housing 1 facing away from the outlet 12 is formed like a sleeve. It is penetrated by a hole 181. At the side facing away from the housing 1, an internal thread 182 is provided. As an alternative to the exemplary embodiment, the connection to the component 18 can also be formed inside a slide lock, a press fit, a clamp fit, or any other quick-lock closure system. Starting at the step 15, a longitudinal groove 17 is inserted in the housing 1, with the control button 8 being guided therein. At its end facing away from the control button 5, the housing 1 is provided with a luer-lock exchange cap 19. The latter is penetrated by a hole 191, with the dosing shaft 2 being able to pass through said hole 191. In addition, the cap 19 comprises a circumferential latching nose 192 adjacent to which a thread 193 is arranged. The cap 19 can be screwed by means of the thread 182 or 14.

The dosing shaft 2 is guided in the hole 11 of the housing 1. It extends almost over the entire length of the hole 11 and, thus, also over the entire length of the housing 1. The dosing shaft 2 is expanding in its diameter, said expansion being spaced apart from its end. In this region, it is provided with an external thread 22 corresponding to the internal thread 14 of the housing 1. The shaft 2 comprises a longitudinal groove in which a key 23 is inserted. With the dosing shaft 2 being in its assembled state, the key 23 is located in the region of the longitudinal groove 17 of the housing 1. In its region facing away from the rotary button 5, the shaft 2 is guided in the hole 131 of the web 13.

The translation shaft 3, which is sectionally surrounding the dosing shaft 2, is made of plastic in the exemplary embodiment. However, it is possible to use other materials as well, for example aluminum, brass, metal, or ceramic material. In essence, the translation shaft has a rotationally symmetric form. The translation shaft 3 is penetrated by a hole which is used to slide said translation shaft 3 onto the dosing shaft 2. The hole comprises a continuous longitudinal groove 32 receiving the key 23 in the assembled state. The combination of the longitudinal groove 32 with the key 23 creates a connection of the dosing shaft 2 to the translation shaft 3, said connection being positive in radial direction. In axial direction, the translation shaft 3 is arranged such that it is sliding along the dosing shaft 2. In the stead of the longitudinal groove, it is also possible to use a stud which engages the key groove.

On its outside, the rotational translation shaft 3 comprises a discharge groove 33. In the view of the translation shaft 3, the discharge groove 33 has the shape of a curve; however, the developed view of the translation shaft 3 results in a straight shape of the discharge groove 33 (FIG. 3). In addition, the translation shaft 3 is provided with a free-running groove 34 which is connected to the discharge groove 33 through a return groove 35. Said return groove 35 provides for pulling back the control button 8 without rotating the dosing shaft 2 in reverse direction. Depending on how the discharge groove 33 and the return groove 35 are distributed over the available 3600 of the translation shaft 3, however, the dosing shaft 2 can generate a discharge motion. In the ideal case, i.e. when the distance to be traveled by the control button 8 matches the pitch of the thread of the dosing shaft 2 in an optimal manner, the discharge stroke is 360° and the return stroke is 0°. The exemplary embodiment comprises a discharge stroke of 280° and a return stroke of 80°. On the side facing the rotary button 5, a disk 36 is arranged on the translation shaft 3, said disk 36 supporting the compression spring 4 in the assembled state. The disk 36 is provided as a protection against wear of the translation shaft 3.

The rotary button 5 is provided with a blind hole 51 pressing the button 5 onto the dosing shaft 2. Marks 52 allowing to read the depth of immersion of the rotary button 5 in the housing 1 are provided on the rotary button 5.

In the exemplary embodiment, the dosing needle 6 is formed with a minor offset angle. This form allows a better adjustment to the particular case of application. Moreover, the offset dosing needle 6 improves access thereto. The inside diameter of the dosing needle can be selected in relation to the particular intended use. The dosing needle 6 comprises a reservoir 61 which is formed like a plastic cap. The reservoir 61 is tapered towards the dosing needle 6. At its end facing away from the dosing needle 6, the reservoir 61 is provided with webs 62 which can be used to fit the reservoir 61 onto the cap 19 of the housing 1 while overcoming the latching nose 192 and to screw said reservoir 61 onto said cap 19 by means of the thread 193. The dosing needle 6 is designed as a disposable part. This is to particular advantage when reactive media having a defined (short) processing time are processed. Since it can be screwed to the housing 1, the dosing needle 6 and the reservoir 61 can be easily assembled and disassembled.

On its side facing the housing 1, the control button 8 is provided with a blind hole, with a bolt 81 screwed into said blind hole. In addition, a slide 82, which is T-shaped in cross-section, is screwed onto the thread. Owing to the T-shaped form, a gap is formed between the outer ends of the slide 82 and the side of the control button 8, which faces the housing 1, the clear width of said gap essentially corresponding to the wall thickness of the housing 1 in the region of the longitudinal groove 17. As a result and in this manner, the control button 8 is guided in the longitudinal groove 17. On its side facing away from the control button 8, the bolt 81 projects beyond the slide 82. In the assembled state, the part of the bolt 82 ((translator's note: this should certainly read 81)) that is projecting beyond the slide 82 is guided in the discharge groove 33 or in the return or free-running grooves of the translation shaft 3.

To use the apparatus according to the present invention for dosing the liquid or pasty media, the medium to be dosed is filled into the reservoir 61. Then the dosing needle 6 is fitted and screwed onto the exchange cap 19. Dosing itself is achieved by moving the control button 8 in the following manner: once the control button 8 is moved along the longitudinal groove 17 toward the outlet 12, the end of the bolt 81 that is guided in the discharge groove 33 of the translation shaft 3 moves along the discharge groove 33. The motion of the control button 8 along the longitudinal direction of the housing 1 causes the translation shaft 3 to start rotating, owing to the fact that the discharge groove 33 is not oriented in parallel to the longitudinal centerline of the apparatus. Since the translation shaft 3 is connected to the dosing shaft 2 in a positive manner, the rotation of the translation shaft 3 is transmitted to the dosing shaft 2.

Owing to the combination of threads 14/22, the rotation of the dosing shaft 2 results in an axial motion of the dosing shaft 2 towards the dosing needle 6. This causes a stroke of the dosing shaft 2 with the result that the dosing shaft 2, in particular the seal 21, is further immersed in the reservoir 61, and this, in turn, causes the dosing medium to be pushed out of the reservoir 61. Since the combination of threads 14/22 is fine-adjusted without any play, small amounts can be dosed with exceptionally high precision. By designing the discharge groove 33 with a different form or by modifying the pitch of the thread 14/22, the stroke can be changed and, thus, it is possible to dose different volumes.

Once the desired amount has been dosed, i.e. the control button 8 has reached its forward stop, the control button 8 is returned to its initial position. This is achieved by simply pulling back the control button 8. Owing to the return groove 35 that is provided in the translation shaft 3, the control button 8 is returned to its initial position without rotation of the translation shaft 3 and, thus, without rotation of the dosing shaft 2. The dosing shaft 2 remains in its position. This prevents the tip of the dosing shaft 2 from retracting out of the reservoir 61 while the control button 8 is returned to its initial position, which might result in air pockets or the like in the reservoir 61 and might lead to adverse effects on the subsequent dosing procedure.

Once the control button 8 has reached its initial position, a new dosing procedure can be started. Since the dosing shaft 2 is in exactly the same position at the beginning of this new dosing procedure as it was at the end of the previous procedure, the new dosing procedure can be carried out without any losses and within exactly the same low tolerance range.

Once the dosing piston has reached its stop after having been actuated repeatedly, the dosing shaft 2 is rotated in reverse direction by means of the rotary button 5. Therein, the free-running groove 34 causes the control button 8 to disengage from the discharge motions (forward helix or reverse helix), with the result that the dosing shaft 2 can be rotated in the thread and back to the head without the control button 8 having to follow the linear motions in a guide.

The marking 52 indicates the number of already completed dosing procedures to the user. By actuating the control button 8, the shaft 2 is rotated and immerses in the reservoir 61. At the same time, the button 5, which is pressed to the shaft 2, immerses in the blind hole 16. The uniformly provided marks 52, which are spaced apart in adjustment to the particular stroke that is defined by the thread, allow the user to read the number of strokes/dosing procedures. Since, in the dosing procedures, the shaft 2 immerses further and further in the reservoir 61 in relation to its stroke, the marks 52 gradually immerse in the blind hole 16. As an alternative to the exemplary embodiment, a hole may be provided in the button 5, with an extended version of the dosing shaft 2 passing through said hole. In this case, the marks provided on the shaft immerse in the button 5 on each stroke.

As an alternative to the aforementioned exemplary embodiment, the exemplary embodiment shown in FIGS. 6 to 8 can be actuated through a motor. Herein, the housing 1 is also penetrated by a hole 11 which is stepped several times. At one of its ends, the housing 1 is closed by the closing cap/rotary button 5. At the end facing away from the closing cap/rotary button 5, the housing 1 is also provided with a component 18 which is designed as an angle head. The luer-lock exchange cap 19 is screwed onto the component 18. The dosing shaft 2 is guided in the exchange cap 19.

An assembly 9 accommodating the components required for actuation of the apparatus through a motor is arranged in the housing 1 including the component 18 designed in the form of an angle head. The assembly 9 consists of a voltage source 91 which is arranged in the hole 11 of the housing 1 in the region facing the closing cap/rotary button 5. The voltage source 91 is connected to a microcontroller circuit 92 which, in turn, is connected to a micromotor 93. On the one hand, the microcontroller circuit 92 can be used to specify the stroke; on the other hand, disabling of the dosing procedure in the event of a malfunction can be provided for safety reasons. As regards the motor 93, it is recommended to use a servomotor, a stepper motor or an electronically controlled or regulated motor. A microdrive 94 is arranged adjacent to the micromotor 93, with the dosing shaft 2 coming out of that end of said microdrive 94 that is facing away from the micromotor 93. A reverse gear is provided for resetting the dosing shaft 2.

A display 95 allowing to show the particular positioning of the dosing shaft 2, including dosing end, filling level in the reservoir or the like, is provided on the outside of the housing 1. In addition, LEDs 96 are provided adjacent to the display 95, said LEDs 96 also being arranged adjacent to the actuation buttons 97, 98. Therein, the LEDs 96 may comprise different colors (for example red and green), thus indicating the particular function of the apparatus. The green LED indicates proper operation, whereas the red LED is lit in the event of a failure. The display 95, the LEDs 96 and the buttons 97, 98 are connected to the microcontroller circuit 92 through cables or conductors. This ensures that actuation of the buttons 97, 98 causes actuation of the dosing apparatus. The button 97 is provided for feeding the dosing shaft 2, while actuation of the button 98 causes the dosing shaft 2 to rotate in reverse direction, this being triggered by inserting the microcontroller 92 and by means of the microdrive 94.

Both the motor-driven variant of the apparatus and the manually actuated variant of the apparatus facilitate dosing of small amounts of liquid or pasty media as well as media containing filling material or reactive media having a defined processing time. Even with very small amounts ranging from 0.01 to 200 μl, preferrably from 0.1 to 20 μl, the media are dosed with exceptionally high precision. Therein, the basic elements, such as the component 18, the exchange cap 19, the needle 6, the dosing shaft 2, as well as the combination of threads between the dosing shaft 2 and the component 18, are contained in either variant alike. It is only the translation shaft 3 of the manually actuated variant that is replaced by the motor revolution of the motor-driven variant.

1. An apparatus for dosing, small amounts of liquid or pasty media as well as media containing filling material or reactive media having a defined processing time, comprising
a housing with an outlet,
a dosing unit which is in communication with said outlet and is arranged in or on said housing,
a reservoir for the medium, which is in communication with said dosing unit and is arranged in or on said housing,
a dosing shaft is axially arranged in the housing, said dosing shaft being sectionally surrounded by a translation shaft, having a discharge groove being inserted in said translation shaft and a control element being guided in said discharge groove, said control element passing through a groove in the housing.

2. The apparatus according to claim 1, wherein the translation shaft is arranged on the dosing shaft such that the translation shaft is axially slideable.

3. The apparatus according to claim 1 wherein the translation shaft comprises return grooves and free-running grooves.

4. The apparatus according to claim 1 further comprising an exchangeable reservoir disposed between the outlet and the dosing shaft.

5. The An apparatus according to claim 1 further comprising markings on the dosing shaft and/or the housing and/or a rotary button (5).

6. An apparatus for dosing small amounts of liquid or pasty media as well as media containing filling material or reactive media having a defined processing time, comprising
a housing with an outlet,
a dosing unit which is in communication with said outlet and is arranged in or on said housing,
a reservoir for the medium, which is in communication with said dosing unit and is arranged in or on said housing,
an electric circuit comprising a microcontroller is provided in the housing, said circuit actuating a dosing shaft by inserting a motor and, if necessary, a drive.

7. The apparatus according to claim 6, wherein the dosing shaft is actuated by means of buttons.

8. The apparatus according to claim 6 further comprising a voltage source arranged in the housing.

9. The apparatus according to claim 6 further comprising a display element on the outside of the housing.

10. The apparatus according to claim 7, comprising at least one LED is provided on the outside of the housing.

11. Method of using an apparatuses according to claim 1 and dosing of small amounts of liquid or pasty media as well as media containing filling material or reactive media having a defined processing time.

12. Method of using an apparatus according to claim 11, wherein the media are dental materials.

13. Method of using an apparatus according to claim 11, wherein the dental materials are adhesives, adhesion promoters or cements.
